(19) United States
(12) Patent Application Publication
(10) Pub. No.: US 2006/0206862 A1
(43) Pub. Date: Sep. 14, 2006

(54) Data processing system for integrating two program frameworks

(76) Inventors: Detlef Becker, Moehrendorf (DE); Karlheinz Dorn, Kalchreuth (DE); Vladyslav Ukis, Nuernberg (DE); Hans-Martin Von Stockhausen, Erlangen (DE)

Correspondence Address: HARNESS, DICKEY & PIERCE, P.L.C., P.O.BOX 8910, RESTON, VA, 20195, US

(21) Appl. No.: 11/363,932

(22) Filed: Mar. 1, 2006

Related U.S. Application Data
(60) Provisional application No. 60/657,415, filed on Mar. 2, 2005.

(51) Int. Cl. G06F 9/44

(52) U.S. Cl. 717/106

(57) ABSTRACT

A data processing system is disclosed, for integrating two program frameworks. The system includes a generic container to communicate with applications implemented in a first framework and to enable them to communicate with one another. A generic component, implemented in the first framework, is included, which provides the functionalities of a second framework. Further, at least one new application is generated via the second framework or via a third framework based on the second framework, which uses the functionalities of the second framework. Finally, an adapter component is included to communicate between the generic component and the at least one new application.

The present application hereby claims priority under 35 U.S.C. §119 on U.S. provisional patent application No. 60/657,415 filed Mar. 2, 2005, the entire contents of which is hereby incorporated herein by reference.

### BACKGROUND

In a modern programming environment, program frameworks (so-called frameworks) provide important functionalities for generating programs so that, for example, the programmer no longer needs to program certain input/output routines explicitly or even in hardware terms but can use prefabricated functions in the framework. Frameworks exist both in traditional procedural languages and in object-oriented languages. In principle, they can be designed independently of a programming language such as, for example, Cocoa by the company Apple or .NET by the company Microsoft, or closely associated with a programming language as is the case, for example, with Java. According to previous experience, the frameworks are changed every 5 to 10 years due to technical advances, so thoroughly that programs written in an old framework would have to be revised for the new framework.

The programming techniques used by the company Microsoft represent an example of such a transition. Currently, there are two different Microsoft technologies which can be utilized as aids in the programming of an application. The more recent one of these technologies is called NET framework and provides very good support in the programming of applications of any type. The code generated by use of the .NET framework is called “Managed Code” whereas the code not generated by means of the .NET framework is called “Unmanaged Code” and represents the older one of the two technologies.

During compilation, the “Managed Code” of an application generated by use of the NET framework is not converted into a sequence of machine instructions which could run directly on a particular computer but into an abstract intermediate code, the so-called “MSIL” (Microsoft Intermediate Language). At the run time of the program, this is in each case recompiled by the so-called Common Language Run Time (CLR), as necessary, and embedded into an executable environment. The background of this intermediate step resides in that it enables various programming languages to access the NET framework.

Since previous applications were mainly generated in unmanaged code, there is a large amount of unmanaged code today at the software companies. However, the new applications can be programmed more rapidly and more efficiently as managed code so that, in principle, it is desirable to use the new framework in this case. In principle, this also applies to other frameworks where in many cases however it would be advantageous to use the old code in order to use the software modules already in existence.

Conversely, it may also be reasonable to expand the preexisting software modules of the old framework, for example unmanaged software modules, by certain more recent functionalities, for example from the managed code area in order to make use of the advantages of the new framework such as, for example, of the .NET framework. Similarly, it is frequently the case that in the case of Windows programming, an unmanaged framework, by which unmanaged applications can be programmed, is to be expanded in such a way that it can also be used for generating managed applications, but the interior of the framework should still remain unchanged as unmanaged. In this case, the applications generated should be exclusively programmed in the NET framework so that the applications do not even notice that they are actually operated by older frameworks.

### SUMMARY

An object of at least one embodiment of the present invention is to provide a possibility by which the applications written in a new framework can operate within an older framework already in existence.

Further advantageous embodiments, aspects and details of the present invention can be obtained from the description and the attached drawings and listings.

At least one embodiment of the invention is based on the concept of providing an adapter which can integrate the new applications in the system from programs of an old framework.

Correspondingly, at least one embodiment of the invention is directed to a data processing system for integrating two program frameworks which exhibits the following:
at least one generic container which can communicate with applications implemented in a first framework and enables them to communicate with one another,
at least one generic component, implemented in the first framework, which provides the functionalities of a second framework,
at least one new application generated by means of the second framework or of a third framework produced by means of the second framework, which uses the functionalities of the second framework, and
at least one adapter component for communicating between the generic component and the new application.

A program framework or framework in the sense of at least one embodiment of the present invention is a framework as it is usually defined by experts in the field, and supports the development of programs by providing functions which can be used in own programs.

A data processing system in the sense of at least one embodiment of the present invention is a plurality of program components and associated run time environment which interact with one another.

A generic container in the sense of at least one embodiment of the present invention is a program component, an object or an application which can link a number of applications or other program components etc. with one another so that they can exchange information with one another and which provides the user with a uniform application interface via which he can call up the functions of the individual applications.

An application in the sense of at least one embodiment of the present invention is any coherent program code which is independently executable or is started by calling up other functions (e.g. DLLs, dynamic link libraries etc.). A communication between the applications is understood to mean that these produce information and forward it to the generic container which forwards it to a further application provided as destination addressee for the information. Examples of this information can be events, data and function calls.

A generic component is a program component such as an independent application, an object, an object group or a dynamic link library which can provide general functionalities for various other components or applications, respectively. It is characterized by the fact that it does not need to be changed in general, even when requirements (e.g. for actual programs) are changing since it is specified on an hierarchically higher level.

A new application, which uses the functionalities of the second framework, is understood to be a newly written application which is based on the second framework, i.e. has been programmed by means of this framework. The new application can also be programmed by means of a third framework based on the second framework, for example containing specific extensions for a particular application logic.

The most important components of the data processing system according to at least one embodiment of the invention are the generic component and the adapter component since these two—in cooperation—enable a new application to run together with old applications in the same generic container.

Providing the functionalities of the second framework by way of the generic component can be effected in various ways. Thus, the generic component can independently reconstruct, i.e. emulate with the aid of the functionalities of the first framework, all functionalities of the second framework in order to provide for smooth running. In a variant example of an embodiment of the invention, however, the generic component is only intended for starting a run time environment for the second framework and contains additional “kit functions” in order to link this run time environment to the generic container code.

The generic component can be, for example, a generically implemented software IC chip. The generic container can advantageously load the applications and the generic component in order to be able to carry out in this manner an interconnection between the individual applications and/or components and the generic container in a coordinated manner.

At least one embodiment of the invention can also be characterized by the fact that interfaces, which are intended for communicating events, are provided at the generic container, the applications, the generic component and/or the adapter component. Such events are to be understood in the sense of “events” of data processing and are generated by applications in particular cases. As a rule, current software systems are event-driven, i.e. the individual components of a software system respond to events which they receive from the outside.

The adapter component and the generic component can be combined in one unit so that no interfaces are necessary between them.

The adapter component is programmed by way of the second framework, in contrast to the generic component which is programmed by way of the first framework. It optionally implements the application-specific third framework based on the second framework or, respectively, the framework extension, if necessary. This framework allows applications to be generated which are based on it and which are exclusively implemented in the second framework. In addition, the adapter component is responsible for forwarding the notifications coming from the first framework such as, for example, events or commands for the applications in the second framework, and conversely.

In one example embodiment, the generic component can perform the compilation of a new application on its first call by the generic container which corresponds to the usual procedure of applications programmed with the .NET framework, which must be compiled from the MSIL (Microsoft Intermediate Language) into a machine language provided for a particular hardware environment. The adapter component, too, can be converted in this manner from IL code or another intermediate code or source text into machine instructions.

The generic container can preferably contain a user interface via which a user can input commands and data which are processed by the applications and/or the at least one new application and/or information is indicated to him which can be generated by the applications and/or the at least one new application. This defines the function of the generic container which serves as interface between user and the programs. The components of the system can be located on an individual workstation/computer and exchange communication via the operating system of the computer or can be designed as distributed system via a computer network and correspondingly use the network mechanisms of the data processing systems for interacting with one another.

The second and the third framework, respectively are preferably based on the NET framework of the Microsoft Corporation.

At least one embodiment of the invention is also directed to a method wherein everything that has been said with respect to the data processing system applies to the method and conversely so that they are alternately referred to.

The method according to at least one embodiment of the invention for integrating applications of a second framework into a functional group with applications of a first framework has the following steps:
providing a generic container which can communicate with applications implemented in a first framework and enables them to communicate with one another;
providing the functionality of a second framework by means of a generic component in a manner which allows communication with the generic container in the manner of the first framework; and
interconnecting at least one new application implemented in the second framework, with the generic component by means of an adapter component so that the new application can run in the second framework or a third framework based on the second framework and, at the same time, can exchange information with the generic container in the manner of the first framework.

The providing of the functionality advantageously includes the starting of a run time environment of the second framework and the setting up of communication channels for connection to the generic container.

In a further example embodiment, the generic component or the adapter component converts events of a framework into events of the other framework in each case and/or forwards them between components and applications of different frameworks.

The method according to at least one embodiment of the invention can also be characterized by the fact that the generic container loads applications implemented in the first framework and new applications into the resultant system.

The system and method according to at least one embodiment of the invention, described above, can be designed, in particular, as computer program product, with a computer-readable medium and a computer program and associated program code segments, the computer being caused to carry out the method according to at least one embodiment of the invention described above in accordance with data of the computer program, i.e. the program system.

An alternative solution to the object provides a storage medium which is intended for storing the computer-implemented method or system of at least one embodiment, described above, and can be read by a computer.

Naturally, it is also possible that more than two program frameworks can be integrated with one another in the inventive manner described above.

In addition, it is possible that the system according to at least one embodiment of the invention is constructed as a heterogeneous system and can be designed partially or completely in hardware and/or software modules distributed over a number of products or commercial units.

### BRIEF DESCRIPTION OF THE DRAWINGS

In the detailed description of the figure which follows, example embodiments, which are to be understood as to be not restrictive, and their features and other advantages are discussed by way of the drawing, in which:

FIG. 1 shows a diagrammatic overview-like representation of the data processing system according to at least one embodiment of the invention.

### DETAILED DESCRIPTION OF THE EXAMPLE EMBODIMENTS

The solution favored in accordance with at least one embodiment of the invention resides in that the traditional and the new functionalities such as, for example a business logic can be allowed to run side by side in a common container (e.g. a business logic container). Traditional applications can be accommodated together with new applications and can communicate with one another via the business logic container. The operation of at least one embodiment of the invention will be explained in greater detail with reference to an example in the text which follows.

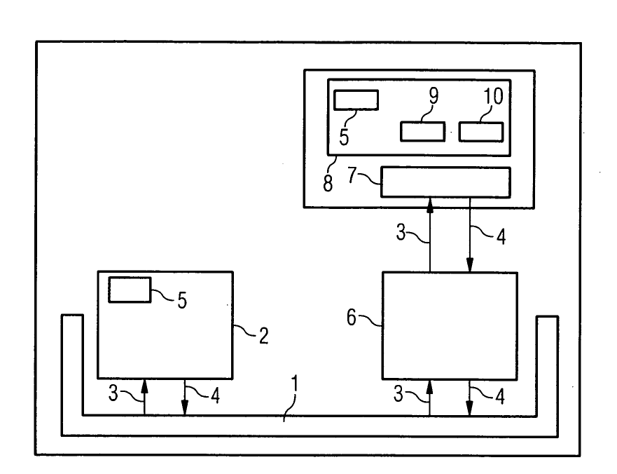

On the left-hand side of FIG. 1, a generic container, for example a business logic container, can be seen which can load arbitrary applications of a framework. For example, unmanaged backend components in the sense of Microsoft program model can be loaded into the container. A backend component always contains the application logic of an application or a part thereof.

The container can notify the components in the case of certain events (framework callbacks 3). Such events are, for example, change of user or a request for preparing the component for a certain event such as, e.g. shut-down. The components 2 themselves can also send out events 4 (notification events) which are delivered by the generic container 1 to the other components of the data processing system when event patterns match.

Within a backend, i.e. an application in the sense of at least one embodiment of the present invention, commands 5 are typically processed. A command normally executes a computationally intensive “job”. Examples of commands of the application logic are a segmentation or the handling of the transfer of a medical image in the case of a medical application. However, the solution according to at least one embodiment of the invention can be used for applications of any fields of application and which are, therefore, highly variable.

The generic backend component 6 on the right-hand side also belongs to the first framework in which component 2 has also been programmed, but plays a special role in the system because it enables the actual application logic to be programmed in NET, in the example embodiment presently selected. This backend component 6 is here called generic backend component or generic component 6, respectively, because it acts itself as a generic container for the application logic in NET. The generic backend 6 represents a generically implemented software IC chip. For the generic container 1, on the other hand, this looks as if the generic component 6 were a conventional backend component, which it is, in the narrower sense, since it has been generated in the first framework, the traditional Microsoft programming environment in the present example.

The generic component internally generates the run time system of NET, the so-called Common Language Run Time (CLR) and hands over control to the adapter component 7, called “DotNetAdapter” in the present case of the .NET framework, which subsequently prepares an infrastructure which enables application developers to program their application logic in .NET. Notifications for the framework are forwarded by the generic container to the generic component 6 and from there to the adapter component 7.

Conversely, the events sent out by the new applications, for example .NET components, are forwarded via the adapter component 7 to the generic component 6 and from there to the generic container 1. This ensures the interoperability between the components in the so-called “unmanaged backend” or another older framework, and the application logic in .NET or other second frameworks.

The new application 8 also contains commands 5. The part-implementations of such commands are handled by business objects (BO) 9 if necessary. The framework notifications (events for the framework) are forwarded by the adapter component 7 to the so-called application object (AO) 10 so that the new application can correspondingly process it there in the case of NET.

Naturally, it is possible to provide, and embed in the generic container 1, more than one generic component 6 and such components can communicate with one another via events and are also notified by the traditional framework. Using the solution according to at least one embodiment of the invention, the developer of an application, hitherto written in an older framework, or of such a system, respectively, can profit from the possibly existing advantages of the more recent second framework.

As a rule, the situation in the case of Microsoft products is that in the case of unmanaged backend components, the developer himself had to determine the structure of his components whereas this is no longer necessary in the case of .NET components since there is much more structure in the application logic. It contains not only commands but also application objects such as business objects which supply part-implementations of the commands, and a dedicated application object which processes the notification of the framework without having to be programmed especially.

The architecture of the application lying over the adapter component is completely configurable in the case of the .NET framework. It is possible to specify an execution architecture by this means. The configuration file for this (in XML) looks as follows:

```
  <\xml version=“1.0” \>
-<APPLICATION>
  -<WORKING_BOX LOGID=“WB_1”>
    -<BUSINESS_COMPONENT LOGID=“BizComp_1”
        TYPE=“syngo.Common.Core.BC1” ASSEMBLY=“\MedCom\i586-
        WinNT5.01_DO\testbin\BC_iTest”>
      -<PROPERTIES>
          <USER_DATA KEY=“MODALITY” VALUE=“AX” />
        </PROPERTIES>
      -<INTERFACES>
          <INTERFACE TYPE=“ITestIntf1” />
          <INTERFACE TYPE=“ITestIntf2” />
        </INTERFACES>
      -<BUSINESS_OBJECT LOGID=“BO_SP” TYPE=“syngo.Common.Core.BO4”
          ASSEMBLY=“\MedCom\i586-WinNT5.01_DO\testbin\BO_iTest”>
        -<PROPERTIES>
            <USER_DATA KEY=“MODALITY” VALUE=“SP” />
            <PROPERTY NAME=“DoubleWithPoint” VALUE=“1.0” />
            <PROPERTY NAME=“DoubleWithComma” VALUE=“1,0” />
        </PROPERTIES>
          -<INTERFACES>
            <INTERFACE TYPE=“ITestIntf1” />
            <INTERFACE TYPE=“ITestIntf2” />
          </INTERFACES>
        </BUSINESS_OBJECT>
    -<BUSINESS_OBJECT LOGID=“BO_SP_2”
        TYPE=“syngo.Common.Core.BO2” ASSEMBLY=“\MedCom\i586-
        WinNT5.01_DO\testbin\BO_iTest”>
        -<INTERFACES>
          <INTERFACE TYPE=“ITestIntf1” />
          <INTERFACE TYPE=“ITestIntf2” />
        </INTERFACES>
        </BUSINESS_OBJECT>
      </BUSINESS_COMPONENT>
    </WORKING_BOX>
  -<WORKING_BOX LOGID=“CT_MR_WB”>
    <COMMAND_OBJECT CHANNEL_ID=“CO_CT”
    TYPE=“syngo.Common.Core.CO1” ASSEMBLY=“\MedCom\i586-
    WinNT5.01_DO\testbin\CO_iTest”/>
  -<BUSINESS_OBJECT LOGID=“BO_CT” TYPE=“syngo.Common.Core.BO1”
      ASSEMBLY=“\MedCom\i586-WinNT5.01_DO\testbin\BO_iTest”>
    -<PROPERTIES>
        <USER_DATA KEY=“MODALITY” VALUE=“I am a CT” />
        <PROPERTY NAME=“TestStringProperty” VALUE=“myValue in
          ConfigFile” />
      </PROPERTIES>
    -<INTERFACES>
          <INTERFACE TYPE=“ITestIntf1” />
      </INTERFACES>
    -<BUSINESS_OBJECT LOGID=“BO_FACTORY_TEST_CHILD”
        TYPE=“syngo.Common.Core.iTest.BO_FactoryTest”
        ASSEMBLY=“\MedCom\i586-WinNT5.01_DO\testbin\BO_iTest”>
      -<INTERFACES>
          <INTERFACE TYPE=“ITestIntf1” />
      </INTERFACES>
      </BUSINESS_OBJECT>
    </BUSINESS_OBJECT>
  -<BUSINESS_OBJECT LOGID=“BO_MR” TYPE=“syngo.Common.Core.BO2”
      ASSEMBLY=“\MedCom\i586-WinNT5.01_DO\testbin\BO_iTest”>
    -<PROPERTIES>
        <USER_DATA KEY=“MODALITY” VALUE=“MR” />
      </PROPERTIES>
    -<INTERFACES>
        <INTERFACE TYPE=“ITestIntf1” />
        <INTERFACE TYPE=“ITestIntf2” />
      </INTERFACES>
    </BUSINESS_OBJECT>
  -<BUSINESS_OBJECT LOGID=“BO_AX” TYPE=“syngo.Common.Core.BO3”
      ASSEMBLY=“\MedCom\i586-WinNT5.01_DO\testbin\BO_iTest”>
    -<PROPERTIES>
        <USER_DATA KEY=“MODALITY” VALUE=“AX” />
      </PROPERTIES>
    -<INTERFACES>
        <INTERFACE TYPE=“ITestIntf1” />
        <INTERFACE TYPE=“ITestIntf2” />
      </INTERFACES>
    -<BUSINESS_OBJECT LOGID=“BO_SP” TYPE=“syngo.Common.Core.BO4”
        ASSEMBLY=“\MedCom\i586-WinNT5.01_DO\testbin\BO_iTest”>
      -<PROPERTIES>
          <USER_DATA KEY=“MODALITY” VALUE=“SP” />
          <PROPERTY NAME=“DoubleWithPoint” VALUE=“1.0” />
          <PROPERTY NAME=“DoubleWithComma” VALUE=“1,0” />
        </PROPERTIES>
      -<INTERFACES>
          <INTERFACE TYPE=“ITestIntf1” />
          <INTERFACE TYPE=“ITestIntf2” />
        </INTERFACES>
      </BUSINESS_OBJECT>
    -<BUSINESS_OBJECT LOGID=“BO_SP_2”
        TYPE=“syngo.Common.Core.BO2” ASSEMBLY=“\MedCom\i586-
        WinNT5.01_DO\testbin\BO_iTest”>
      -<INTERFACES>
          <INTERFACE TYPE=“ITestIntf1” />
          <INTERFACE TYPE=“ITestIntf2” />
        </INTERFACES>
      </BUSINESS_OBJECT>
    </BUSINESS_OBJECT>
  </WORKING_BOX>
-<APPLICATION_OBJECT LOGID=“AO” TYPE=“syngo.Common.Core.AO”
    ASSEMBLY=“\MedCom\i586-WinNT5.01_DO\testbin\AO_iTest”>
  -<SERVICE LOGID=“CONFIG_SERVICE”
      TYPE=“syngo.Common.Core.iTest.SC_Config”
      ASSEMBLY=“\MedCom\i586-WinNT5.01_DO\testbin\SC_iTestd.dll”>
    -<INTERFACES>
        <INTERFACE TYPE=“IConfig_{——}” />
      </INTERFACES>
    </SERVICE>
  </APPLICATION_OBJECT>
</APPLICATION>
```

This configuration contains two “working boxes”. At operating system level, a working box corresponds to a thread or also to an execution path within an application. In the working boxes, business objects can be found which run in these threads. As can be seen from the listing, even the threading model can be configured. In addition, there is an object for processing commands and a global application object.

In the text which follows, code sections for the generic component, relevant to the performance of at least one embodiment of the invention, and the adapter component (DotNetAdapter) are presented in the programming language C++:

```
class GenBE : public GenericComponent
{
public:
  GenBE( );
  ˜GenBE( );
  int open (void *);
  int close(unsigned long);
      int suspend(void);
      int resume(void);
      int activateComp(void);  // used for tabcard activation in FE
protected:
  bool processArgs(int theKey, char *theArg);
  void handleApplicationEventEx(AtEvent &evObj); // incoming application
event
  void handleModalityEventEx(AtEvent &evObj);
  bool handleShutdownRequest(bool theReqType, LPTSTR *);
  bool handleSaveRequest(int);
    bool handleUserLoginRequest(bool, const CsaSecUserToken &, CsaAtString
&);
  bool handleUserLogin(const CsaSecUserToken &, CsaAtString &);
  bool handleUserLogout(const CsaSecUserToken &, CsaAtString &);
    bool handleSystemMsg(const CsaAtString &, CsaAtString &);
  BOOL handleUserLogoutRequest(bool, const CsaAtString &, CString &);
  bool handleCloseData(const CsaAtString &, const CsaAtString &, bool,
CsaAtString &);
  bool handleCloseDataRequest(bool, const CsaAtString &, const CsaAt-
String &,
      bool, CsaAtString &);
private:
  IDotNetATAdapter::IDotNetATAdapter* myDotNetAdapter;
    CsaAtString myXMLFile;
  CsaAtString myModalityChannel;
  CsaAtString myApplicationChannel;
  CCsaClrHostingHelper myCsaClrHostingHelper;
};
int GenBE::open (void *)
{
      HRESULT hr = myCsaClrHostingHelper.initCLR( );
      if (FAILED(hr))
      {
        GENBE_ERROR( “Failed to load CLR “ << ” (0x“ << hex << hr <<
”)” );
        return false;
      }
      // bind to AppDomain for this application
      hr = myCsaClrHostingHelper.bindAppDomain( );
    if (FAILED(hr))
    {
          GENBE_ERROR( “Failed to bind to AppDomain ‘“ << ”’ (0x“ << hex
<< hr << ”)” );
          return false;
    }
    // create managed part of our hosting system in the correct
//AppDomain
    mscorlib::_ObjectHandle *pObjHandle = NULL;
    hr = myCsaClrHostingHelper.createDotNetAssembly(pObjHandle);
    if (FAILED(hr) || pObjHandle == NULL)
    {
          GENBE_ERROR(“failed to create .NET adapter: “ << ”’ (0x“ <<
hex << hr << ”)”);
          return false;
    }
    // get dispatch ptr to actual repository object
  VARIANT v;
  VariantInit(&v);
  hr = pObjHandle->Unwrap(&v);
  if (FAILED (hr) || v.pdispVal == 0)
  {
      GENBE_ERROR(“failed to unwrap handle of .NET adapter (0x“ << hex
<< hr << ”)” );
      pObjHandle->Release( );
      return false;
  }
  // get object ptr to actual repository object
  hr = v.pdispVal-
>QueryInterface(IDotNetATAdapter::IID_IDotNetATAdapter, (void**)
&myDotNetAdapter);
  v.pdispVal->Release( ); // we now have the actual interface...
  if (FAILED(hr) || myDotNetAdapter == 0)
  {
      GENBE_ERROR(“failed to retrieve interface of .NET adapter (0x“ <<
hex << hr << ”)” );
      return false;
  }
    // initialize DotNetAdapter
  _bstr_t anXMLFile = myXMLFile;
    LPSTR aConfigLine = NULL;
    (void)info(&aConfigLine, 0);
    _bstr_t aBstrConfigLine = aConfigLine;
  VARIANT_BOOL aBoolRslt = myDotNetAdapter->Init((long)this, anXMLFile,
aBstrConfigLine);
  if (!aBoolRslt)
  {
          GENBE_ERROR(“Initialization of .NET-Adapter failed”);
        return false;
  }
    else
  {
    GENBE_INFO(“.NET-Adapter successfully created” );
  }
  return true;
}
DotNetAdapter
  public sealed class DotNetAdapter : AbstractDotNetAdapter, IDotNetAT
Adapter
  {
    /// <summary>
    /// contains this pointer of GenBE
    /// </summary>
    /// {secret}
    private int myGCompContext = 0;
    /// <summary>
    /// current application doman name
    /// </summary>
    /// {secret}
    private string myAppDomainName = AppDomain
.CurrentDomain.FriendlyName;
    /// <summary>
    /// contains list of command channel IDs
    /// </summary>
    /// {secret}
    private StringCollection myCmdObjects = new StringCollection ( );
    /// <summary>
    /// reference to GenCmdOCX
    /// </summary>
    /// {secret}
    //private GenCmdClass myGenCmdOcx = null;
    private ICommunicationMediator myGenCmdOcx = null;
    /// <summary>
    /// Application channel name
    /// </summary>
    private string myApplicationChannel = “”;
    /// <summary>
    /// Application channel name
    /// </summary>
    /// {secret}
    public string ApplicationChannel
    {
      get
        {
        return myApplicationChannel;
      }
      set
      {
        myApplicationChannel = value;
      }
    }
    /// <summary>
    /// Modality channel name
    /// </summary>
    private string myModalityChannel = “”;
    /// <summary>
    /// Modality channel name
    /// </summary>
    /// {secret}
    public string ModalityChannel
    {
      get
      {
        return myModalityChannel;
      }
      set
      {
        myModalityChannel = value;
      }
    }
    public override ICommunicationMediator GenCmd
      {
      get
        {
        if (myGenCmdOcx == null)
        {
          try
          {
            myGenCmdOcx = CreateCommunicationMediator ( );
            if (myGenCmdOcx != null)
            {
              myGenCmdOcx.CommunicationMode =
CommunicationType.ClassicGenCmd;
            }
          }
          catch (Exception e)
          {
            Trace.Warn(this, “Failed to create
GenCmd.ocx”, e);
          }
        }
          return myGenCmdOcx;
        }
    }
    ICommunicationMediator CreateCommunicationMediator( )
    {
      return new CommunicationMediator( );
    }
    #region IEventBroadcast
    /// <summary>
    /// sends an application event
    /// </summary>
    /// <param name=“theEvent”></param>
    /// {secret}
    public override void NotifyApplication(IATEvent theEvent)
    {
      Trace.Info(this, “Sending Application Event on channel
=‘” +
        ApplicationChannel +
        “’. EventString=‘” + theEvent.EvtStr +
        “’, UserID=‘“ + theEvent.UserID + “’”);
      COMGCompHelper.NotifyApplication(myGCompContext,
        theEvent.EvtStr,
        theEvent.UserID);
    }
    /// <summary>
    /// sends a modality event
    /// </summary>
    /// <param name=“theEvent”></param>
    /// {secret}
    public override void NotifyModality(IATEvent theEvent)
    {
      Trace.Info(this, “Sending Modality Event on channel=‘” +
        ModalityChannel +
        “’. EventString=‘” + theEvent.EvtStr +
        “’, UserID=‘” + theEvent.UserID + “’”);
      COMGCompHelper.NotifyModality(myGCompContext,
        theEvent.EvtStr,
        theEvent.UserID);
    }
    #endregion
    #region AbstractDotNetAdapter specific
    private IWorkingBoxRouter myWorkingBoxRouter = null;
    public override IWorkingBoxRouter WorkingBoxRouter
    {
      get
      {
        return new WorkingBoxRouter( );
      }
      set
      {
        myWorkingBoxRouter = value;
      }
    }
    /// <summary>
    /// creates a working box
    /// </summary>
    /// {secret}
    /// <returns>wboxID</returns>
    public override int CreateWorkingBox( )
    {
      int aWBoxID = 0;
      try
      {
        if (GenCmd != null)
        {
          aWBoxID = GenCmd.InitServerWorkingBox( );
        }
      }
      catch(Exception)
      {
        throw new ATException(“WorkingBox hasn't been created ”);
      }
      return aWBoxID;
    }
    /// <summary>
    /// initializes a server command channel
    /// </summary>
    /// <param name=“channel”>server channel name</param>
    /// <param name=“assembly”>assembly name implementing a command</param>
    /// <param name=“type”>command's class name</param>
    /// <param name=“correspIntfRepCookie”>cookie under which a
Site object
    /// for this command object is stored in the Data property of
the current AppDomain
    /// </param>
    /// <param name=“wBoxID”></param>
    /// {secret}
    public override string InitCommandChannel(string channel,
      string assembly,
      string type,
      string correspIntfRepCookie,
      int wBoxID)
    {
      string cmdDescr = assembly + “,” +
        type + “,” +
        correspIntfRepCookie + “,” +
        myAppDomainName;
      string aCmdID = “”;
      if (GenCmd != null)
      {
        aCmdID = GenCmd.InitServerCommandChannel(channel,
          “InternalDotNet”,
          cmdDescr,
          wBoxID);
      }
      if (aCmdID != “”)
      {
        myCmdObjects.Add(aCmdID);
        Trace.Info(this, “Registered Command Object: ” +
          “Type=‘” + type + “’, ” +
          “CmdID=‘” + aCmdID + “’, ” +
          “Channel=‘” + channel + “’, ” +
          “WBox=‘” + wBoxID + “’, ” +
          “Assembly=‘” + assembly + “’”);
      }
      else
      {
        Trace.Warn(this, “Could not register the command
object: ” +
          “Type=‘” + type + “’, ” +
          “CmdID=‘” + aCmdID + “’, ” +
          “Channel=‘” + channel + “’, ” +
          “WBox=‘” + wBoxID + “’, ” +
          “Assembly=‘” + assembly + “’”);
      }
      return aCmdID;
    }
    #endregion
    /// <summary>
    /// Called by the AT-Framework to initialize the whole BE-part
of the
    /// application
    /// Processes the specified XML configuration
    /// Establishes the connection to the AT-Framework
    /// </summary>
    /// <param name=“theGCompContext”>this pointer of
GenBE</param>
    /// <param name=“theConfigFile”>XML configuration file of
AT.NET Application</param>
    /// <param name=“theConfigLine”>Configuration line of
GenBE</param>
    /// <returns></returns>
    /// {secret}
    public bool Init(int theGCompContext, string theConfigFile,
string theConfigLine)
    {
      myGCompContext = theGCompContext;
      return base.Init(theConfigFile);
    }
    #region IATCallbacks
    /// <summary>
    /// destroys commands, working boxes, BOs and AO
    /// </summary>
    /// <param name=“theValue”>is ignored</param>
    /// <returns></returns>
    /// {secret}
    public override int Close (int theValue)
    {
      return base.Close(theValue);
    }
    public override void DestroyWorkingBoxes( )
    {
      if (myGenCmdOcx != null)
      {
        if (!myGenCmdOcx.ExitServerWorkingBoxes( ))
        {
          Trace.Warn(this
            , “Encountered some problems during
closing of working boxes”);
        }
      }
    }
    /// <summary>
    /// destroys cmd objects
    /// </summary>
    private void DestroyCommandObjects( )
    {
      foreach (string aCmdID in myCmdObjects)
      {
        if (myGenCmdOcx != null)
        {
          if (!myGencmd Ocx.ExitServerCommandChannel(aCmdID))
          {
            Trace.Warn(this
              , “Encountered some problems
while closing ”
              + “ the server command channel
with CmdID=‘” + aCmdID + “’”);
          }
        }
      }
      myCmdObjects.Clear( );
    }
    public override void ExitCommandChannel(string theChannelID)
    {
      if (myGenCmdOcx != null)
      {
        if (!myGenCmd
Ocx.ExitServerCommandChannel(theChannelID))
        {
          Trace.Warn(this
            , “Encountered some problems while
closing ”
            + “ the server command channel with
ChannelID=‘” + theChannelID + “’”);
        }
      }
    }
    /// <summary>
    /// handles application event
    /// </summary>
    /// <param name=“theEvent”></param>
    /// <param name=“theUserToken”></param>
    /// {secret}
    public void HandleApplicationEvent_(string theEvent, string
theUserToken)
    {
      IATEvent anEvent = new ATEvent(theEvent,theUserToken);
      HandleApplicationEventEx(anEvent);
    }
    /// <summary>
    /// handles modality event
    /// </summary>
    /// <param name=“theEvent”></param>
    /// <param name=“theUserToken”></param>
    /// {secret}
    public void HandleModalityEvent_(string theEvent, string
theUserToken)
    {
      IATEvent anEvent = new ATEvent(theEvent,theUserToken);
      HandleModalityEventEx(anEvent);
    }
}
```

Using the generic component and the adapter component makes it possible to program the application logic of the applications of a first framework both by way of a first framework and by way of a second, for example more modern framework. The applications programmed in various technologies can communicate in the same manner as applications have previously communicated with one another within an application framework.

Thus, for example, a managed application of the NET framework includes architectural components which can be exclusively programmed in NET. This provides the application developer with the ability to decide himself whether he wishes to utilize, for example, the advantages of the .NET framework and, because of that, to program his application as “managed code” or wishes to stay with the old “unmanaged” technology. Interoperability with the old applications of the developer is given if the new application is programmed as “managed code”.

The realization of at least one embodiment of the invention does not require any basic changes in the previous prior art but, in principle, can also be inserted subsequently as module—particularly as modified or additional computer program product.

Finally, it should be pointed out that, in principle, the description of the example embodiments of the invention are not meant to be restrictive with regard to a particular physical implementation of the invention. In particular, it is clear to the relevant expert that the example embodiments of invention can be implemented partially or completely in software and distributed to a number of physical products, including also computer program products, in particular.

Any of the aforementioned methods may be embodied in the form of a system or device, including, but not limited to, any of the structure for performing the methodology illustrated in the drawings.

Further, any of the aforementioned methods may be embodied in the form of a program. The program may be stored on a computer readable media and is adapted to perform any one of the aforementioned methods when run on a computer device (a device including a processor). Thus, the storage medium or computer readable medium, is adapted to store information and is adapted to interact with a data processing facility or computer device to perform the method of any of the above mentioned embodiments.

The storage medium may be a built-in medium installed inside a computer device main body or a removable medium arranged so that it can be separated from the computer device main body. Examples of the built-in medium include, but are not limited to, rewriteable non-volatile memories, such as ROMs and flash memories, and hard disks. Examples of the removable medium include, but are not limited to, optical storage media such as CD-ROMs and DVDs; magneto-optical storage media, such as MOs; magnetism storage media, such as floppy disks (trademark), cassette tapes, and removable hard disks; media with a built-in rewriteable non-volatile memory, such as memory cards; and media with a built-in ROM, such as ROM cassettes.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A data processing system for the integration of two program frameworks, comprising:
a generic container to communicate with applications implemented in a first framework and to enable the applications to communicate with one another;
a generic component, implemented in the first framework, to provide the functionalities of a second framework;
at least one new application, generated via at least one of the second framework and a third framework produced by the second framework, to use the functionalities of the second framework; and
an adapter component to communicate between the generic component and the at least one new application.

2. The data processing system as claimed in claim 1, wherein the generic component is intended to start a run time environment for the second framework.

3. The data processing system as claimed in claim 1, wherein the generic component is a generically implemented software IC chip.

4. The data processing system as claimed in claim 1, wherein the generic container is adapted to at least one of load and loads the applications and the generic component.

5. The data processing system as claimed in claim 1, wherein interfaces, to communicate events, are provided at the generic container, the applications, the generic component and the adapter component.

6. The data processing system as claimed in claim 1, wherein the generic component and the adapter component are combined in one unit.

7. The data processing system as claimed in claim 1, wherein the adapter component is programmed by the second framework and implements a third, application-specific framework.

8. The data processing system as claimed in claim 1, wherein the generic component is intended to carry out a compilation of a new application and optionally of the adapter component on its first call by the generic container.

9. The data processing system as claimed in claim 1, wherein the generic container contains a user interface via which a user can input commands and data which are at least one of processed by at least one of the applications, processed by the at least one new application and via which information is indicated to him which is generatable by at least one of the applications and the at least one new application.

10. The data processing system as claimed in claim 1, wherein the components of the system are designed to be distributed in a computer network.

11. The data processing system as claimed in claim 1, wherein the second and the third framework, respectively, are based on the NET framework of the Microsoft Corp.

12. A method for integrating applications of a second framework into a functional group with applications of a first framework, comprising:
providing a generic container to communicate with applications implemented in a first framework and to enable the applications to communicate with one another;
providing functionality of a second framework via a generic component in a manner which allows communication with the generic container in the manner of the first framework; and
interconnecting at least one new application, implemented in the second framework, with the generic component via an adapter component to permit the at least one new application to run in at least one of the second framework and a third framework based on the second framework, and at the same time to exchange information with the generic container in the manner of the first framework.

13. The method as claimed in claim 12, wherein the providing of the functionality includes the starting of a run time environment of the second framework and the setting up of communication channels for connection to the generic container.

14. The method as claimed in claim 12, wherein at least one of the generic component and the adapter component at least one of converts events of a framework into events of the other framework in each case and forwards them between components and applications of different frameworks.

15. The method as claimed in claim 12, wherein the generic container loads applications implemented in the first framework and the at least one new application into the resultant system.

16. A computer program, adapted to, when executed on a computer, cause the computer to carry out the method as claimed in claim 12.

17. A computer program product, including the computer program of claim 16.

18. A computer readable medium including program segments for, when executed on a computer, causing the computer to implement the method of claim 1.

19. A data processing system for the integration of two program frameworks, comprising:
means for communicating with applications implemented in a first framework and for enabling the applications to communicate with one another;
means, implemented in the first framework, for providing the functionalities of a second framework;
at least one new application means, generated via at least one of the second framework and a third framework produced by the second framework, for using the functionalities of the second framework; and
means for communicating between the generic component and the at least one new application.

20. The data processing system as claimed in claim 19, wherein the means implemented in the first framework is intended to start a run time environment for the second framework.

21. The data processing system as claimed in claim 19, wherein the means implemented in the first framework is a generically implemented software IC chip.

22. A system for integrating applications of a second framework into a functional group with applications of a first framework, comprising:
means for providing a generic container to communicate with applications implemented in a first framework and to enable the applications to communicate with one another;
means for providing functionality of a second framework via a generic component in a manner which allows communication with the generic container in the manner of the first framework; and
means for interconnecting at least one new application, implemented in the second framework, with the generic component via an adapter component to permit the at least one new application to run in at least one of the second framework and a third framework based on the second framework, and at the same time to exchange information with the generic container in the manner of the first framework.

23. The system as claimed in claim 22, wherein the means implemented in the first framework is intended to start a run time environment for the second framework.

24. The system as claimed in claim 22, wherein the means implemented in the first framework is a generically implemented software IC chip.
